(19) United States
(12) Patent Application Publication
(10) Pub. No.: US 2025/0380054 A1
(43) Pub. Date: Dec. 11, 2025

(54) IMAGING APPARATUS AND INTERCHANGEABLE LENS

(71) Applicant: Panasonic Intellectual Property Management Co., Ltd., Osaka (JP)

(72) Inventors: Yasuhiro SHINGU, Osaka (JP); Takakazu BITO, Osaka (JP)

(73) Assignee: Panasonic Intellectual Property Management Co., Ltd., Osaka (JP)

(21) Appl. No.: 19/228,844

(22) Filed: Jun. 5, 2025

(30) Foreign Application Priority Data
Jun. 10, 2024 (JP) 2024-093699

(51) Int. Cl. H04N 23/663; H04N 23/55; H04N 23/63; H04N 23/667; H04N 23/69

(52) U.S. Cl. CPC H04N 23/663; H04N 23/55; H04N 23/632; H04N 23/667; H04N 23/69

(57) ABSTRACT

An imaging apparatus includes: a communication interface that communicates data with an attached interchangeable lens; an image sensor that captures a subject image via the interchangeable lens to generate image data; a controller that controls an operation of the interchangeable lens with data communication via the communication interface; an image processor that performs electronic zoom processing; and a setting interface that sets the electronic zoom processing to a first operation member in the interchangeable lens, in response to a user operation. When the electronic zoom processing is not set to the first operation member, the controller controls the interchangeable lens to perform a predetermined operation in response to a user operation. When the electronic zoom processing is set to the first operation member, the controller disallows the predetermined operation by the interchangeable lens and controls the image processor to perform the electronic zoom processing in response to the user operation.

### TECHNICAL FIELD

The present disclosure relates to an imaging apparatus having an electronic zoom function, and an interchangeable lens that can be attached to the imaging apparatus.

### BACKGROUND ART

JP 2002-072051 A discloses an imaging apparatus that enables manual focus operation and manual zoom operation with one ring device. The imaging apparatus includes an optical lens system such as a focus lens and a zoom lens, a switching switch for switching between a manual focus mode and an autofocus mode, and a rotation ring device. The rotation ring device functions as a ring for manual zoom operation when the changeover switch is switched to the autofocus mode, and performs optical zoom control to drive the zoom lens with a zoom motor.

### SUMMARY

The present disclosure provides an imaging apparatus and an interchangeable lens that can facilitate use of electronic zoom of an imaging apparatus.

In the present disclosure, an imaging apparatus to which an interchangeable lens is detachably attachable, including: a communication interface that communicates data with the attached interchangeable lens; an image sensor that captures a subject image via the interchangeable lens to generate image data; a controller that controls an operation of the interchangeable lens with data communication via the communication interface; an image processor that performs electronic zoom processing to crop an image at a variable magnification from the image data generated by the image sensor; and a setting interface that sets the electronic zoom processing to a first operation member in response to a user operation of the setting interface, the first operation member being provided in the interchangeable lens. When the electronic zoom processing is not set to the first operation member by the setting interface, the controller controls the interchangeable lens to perform a predetermined operation in response to a user operation of the first operation member. When the electronic zoom processing is set to the first operation member by the setting interface, the controller disallows the predetermined operation by the interchangeable lens and controls the image processor to perform the electronic zoom processing in response to the user operation of the first operation member.

In the present disclosure, an interchangeable lens detachably attachable to an imaging apparatus, including: a communication interface that communicates data with the attached imaging apparatus; an optical system that forms an image on an image sensor of the imaging apparatus, based on incident light; an operation member that receives a user operation for the optical system; and a controller that controls an operation of the optical system according to the user operation of the operation member, based on information received from the imaging apparatus via the communication interface. When electronic zoom processing of the imaging apparatus is not set to the operation member, the controller performs a predetermined operation by the optical system in response to the user operation of the operation member. When the electronic zoom processing is set to the operation member, the controller does not perform the predetermined operation by the optical system in response to the user operation of the operation member.

According to the imaging apparatus and the interchangeable lens in the present disclosure, electronic zoom of the imaging apparatus can be easily used.

### BRIEF DESCRIPTION OF DRAWINGS

FIG. 1 is a block diagram illustrating a configuration of a digital camera according to a first embodiment of the present disclosure;

FIG. 2 is a rear view of a camera body in the digital camera;

FIG. 3 is a diagram illustrating a configuration of a manual focus (MF) ring in an interchangeable lens of a digital camera;

FIG. 4 is a timing chart illustrating a detection signal of the MF ring in the interchangeable lens;

FIG. 5 is a diagram for explaining an electronic zoom function in the digital camera;

FIG. 6 is a sequence diagram illustrating an initial communication operation in the digital camera;

FIG. 7 is a flowchart illustrating electronic zoom setting processing in the digital camera of the first embodiment;

FIGS. 8A to 8C are diagrams illustrating a display example of a setting menu in the digital camera of the first embodiment;

FIG. 9 is a sequence diagram illustrating an electronic zoom operation in the digital camera of the first embodiment;

FIG. 10 is a diagram illustrating a display example in an electronic zoom operation of the digital camera;

FIG. 11 is a sequence diagram illustrating a hybrid zoom operation in the digital camera of the first embodiment;

FIG. 12 is a block diagram illustrating a configuration of a digital camera according to a second embodiment;

FIGS. 13A to 13C are diagrams illustrating a display example of a setting menu in the digital camera of the second embodiment;

FIG. 14 is a sequence diagram illustrating a hybrid zoom operation in the digital camera of the second embodiment;

FIG. 15 is a sequence diagram illustrating an electronic zoom operation in the digital camera of the second embodiment; and

FIG. 16 is a block diagram illustrating a configuration of a digital camera of a modification of the first embodiment.

### DETAILED DESCRIPTION

Hereinafter, an embodiment will be described in detail with reference to the drawings as appropriate. However, unnecessarily detailed description may be omitted. Note that the accompanying drawings and the following description are provided for those skilled in the art to fully understand the present disclosure, and are not intended to limit the subject matter described in the claims.

### First Preferred Embodiment

Hereinafter, a configuration and operation of an embodiment of an imaging apparatus of the present disclosure will be described.

### 1. Configuration

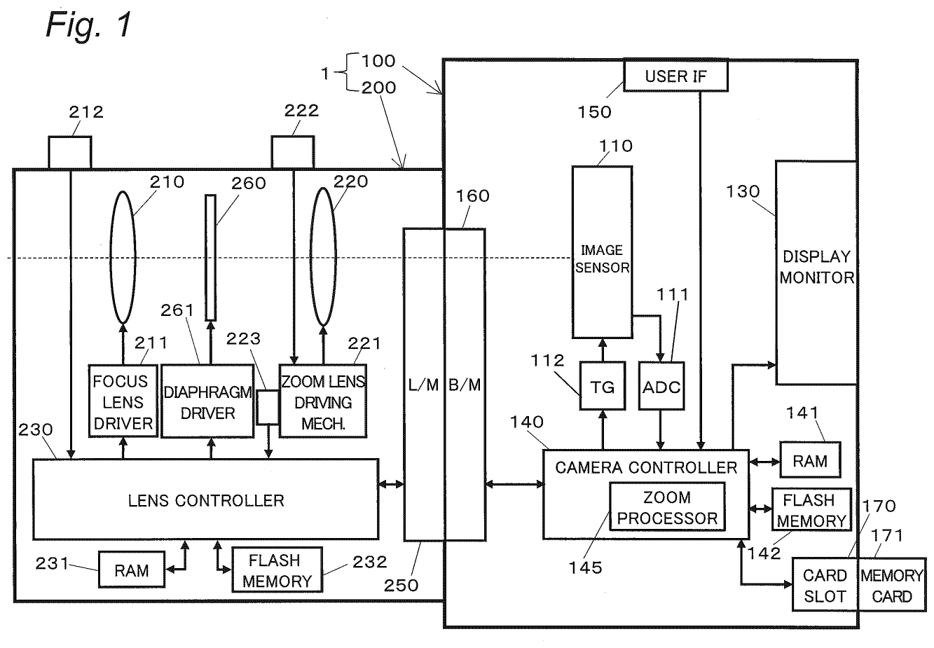

FIG. 1 is a block diagram illustrating a configuration of a digital camera 1 according to a first embodiment. The digital camera 1 of the present embodiment includes a camera body 100 and an interchangeable lens 200 detachable from the camera body 100.

### 1-1. Camera Body

The camera body 100 (an example of the imaging apparatus) includes an image sensor 110, a display monitor 130, a user interface 150, a camera controller 140, a RAM 141, a flash memory 142, a body mount 160, and a card slot 170. Furthermore, the camera body 100 includes a zoom processor 145 that realizes an electronic zoom function, for example, as a functional configuration of the camera controller 140.

The image sensor 110 is an element that captures a subject image incident via an interchangeable lens 200 and generates image data (also referred to as imaging data). The image sensor 110 is, for example, a CMOS image sensor. The generated image data is digitized by an AD converter (ADC) 111. The digitized image data is subjected to predetermined image processing by the camera controller 140. Examples of the predetermined image processing include gamma correction processing, white balance correction processing, scratch correction processing, YC conversion processing, electronic zoom processing, and JPEG compression processing. The image sensor 110 may be a CCD or NMOS image sensor.

The image sensor 110 operates at a timing controlled by a timing generator (TG) 112. The image sensor 110 generates a still image or a moving image for recording, or a live view image. The live view image is an example of a moving image displayed on the display monitor 130 in order to visualize the real-time imaging result by the image sensor 110 to a user.

The display monitor 130 is an example of a display that displays at least one of an image such as a live view image or various information such as a menu screen on a display screen. The display monitor 130 can include, for example, various display devices such as a liquid crystal display device or an organic EL device. In addition to or instead of the display monitor 130, the digital camera 1 may include, for example, an electronic viewfinder (EVF) or the like having a display screen as an example of another display in the camera body 100.

The user interface 150 is a general term of a user interface to which an operation (instruction) from the user can be input. When receiving an input of a user operation, the user interface 150 transmits an operation signal indicating various instructions according to the user operation to the camera controller 140. The user interface 150 includes, for example, physical buttons, levers, dials, touch panels, switches, and the like. Furthermore, the user interface 150 may also include a virtual button or icon displayed on the display monitor 130.

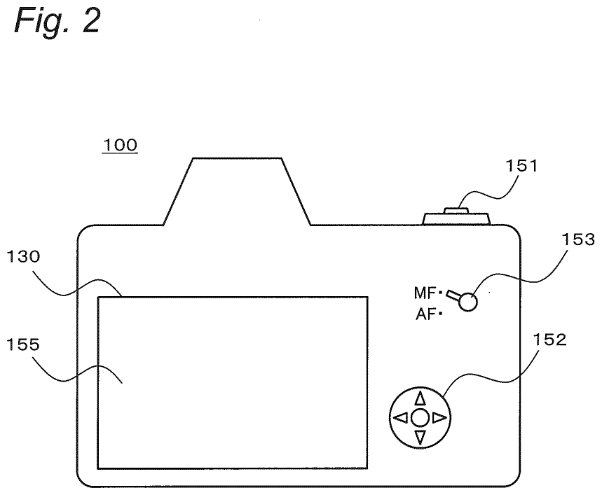

In FIG. 2, a release button 151, a direction button 152, a focus selection lever 153, and a touch panel 155 are illustrated as examples of the user interface 150 of the camera body 100. For example, a setting menu of the digital camera 1 can be operated by the user interface 150. The user interface 150 is an example of a setting interface in the present embodiment.

The focus selection lever 153 is an example of a switcher that switches the operation mode in the setting interface of the digital camera 1. In the example of FIG. 2, the focus selection lever 153 is configured to be switchable between two operation modes including a manual focus (MF) mode and an autofocus (AF) mode, but is not particularly limited thereto, and may be configured to be switchable between three or more operation modes. Such an operation mode to be switched may include an operation mode for various focusing operations such as an AF-S (single AF) mode and an AF-C (continuous AF) mode, that is, a focus mode, or may include other operation modes.

The camera controller 140 controls the entire operation of the digital camera 1 by controlling components such as the image sensor 110 according to an instruction from the user interface 150. The camera controller 140 may be configured by a hard-wired electronic circuit, a microcomputer that executes a program, or the like. The camera controller 140 transmits a vertical synchronization signal to the timing generator 112. In parallel with this, the camera controller 140 generates a synchronization signal synchronized with the vertical synchronization signal, and transmits the synchronization signal to the lens controller 230 via the body mount 160 and a lens mount 250. The camera controller 140 uses the RAM 141 as a work memory during control operation and image processing operation.

For example, the zoom processor 145 in the camera controller 140 executes zoom processing that implements an electronic zoom function by image processing of cropping an image in the image data from the image sensor 110 and resizing the cropped image. Details of such a zoom processor 145 will be described later. The zoom processor 145 is an example of an image processor in the present embodiment. The zoom processor 145 is not limited to the functional configuration of the camera controller 140, and may be, for example, an image processing circuit separate from the camera controller 140.

The flash memory 142 stores programs and parameters used when the camera controller 140 performs control.

The body mount 160 can be mechanically and electrically connected to the lens mount 250 of the interchangeable lens 200. The body mount 160 can transmit and receive data to and from the interchangeable lens 200 via the lens mount 250. The body mount 160 transmits the exposure synchronization signal received from the camera controller 140 to the lens controller 230 via the lens mount 250.

In addition, the body mount 160 transmits other control signals received from the camera controller 140 to the lens controller 230 via the lens mount 250. Furthermore, the body mount 160 transmits a signal received from the lens controller 230 via the lens mount 250 to the camera controller 140.

A memory card 171 can be inserted into the card slot 170, and the memory card 171 is controlled based on control from the camera controller 140. The digital camera 1 can store image data in the memory card 171 and read image data from the memory card 171.

### 1-2. Interchangeable Lens

As illustrated in FIG. 1, the interchangeable lens 200 includes an optical system including, for example, a focus lens 210, a zoom lens 220, a diaphragm 260, and the like. The interchangeable lens 200 further includes various drivers 211, 221, and 261, a lens controller 230, a RAM 231, a flash memory 232, and a lens mount 250. Furthermore, the interchangeable lens 200 may further include a camera shake correction lens in addition to the lens illustrated in FIG. 1.

The interchangeable lens 200 further includes operation members such as a MF ring 212 and a zoom ring 222. The operation member of the interchangeable lens 200 is not limited thereto, and may include, for example, a lever provided on an exterior.

The lens controller 230 controls the entire operation of the interchangeable lens 200. The lens controller 230 may be constructed with a hard-wired electronic circuit or a microcomputer that executes a program.

The RAM 231 functions as a work memory used when the lens controller 230 performs control. The flash memory 232 stores programs, parameters, lens data, and the like used for control by the lens controller 230.

The zoom lens 220 is a lens for changing magnification of a subject image formed by the optical system of the interchangeable lens 200. A lens configuration of the zoom lens 220 may be any number of lenses or any number of groups. The zoom lens drive mechanism 221 is a mechanical mechanism (e.g., a cam mechanism) that moves the zoom lens 220 along the optical axis of the optical system on the basis of the operation of the zoom ring 222 by the user. The position of the zoom lens 220 is detected by the zoom lens position detection unit 223 as needed, and is notified to the lens controller 230. Each of the units 220 to 223 for such optical zoom is an example of an optical zoom mechanism in the camera body 100.

The zoom ring 222 has a predetermined angular range (e.g.,) 90° within which an optical focal length of the zoom lens 220 in the interchangeable lens 200 is movable between a wide-angle end that is shortest and a telephoto end that is longest. The zoom ring 222 is an example of an operation member that can perform a zoom operation by operating at various rotation angles within the angular range.

The diaphragm 260 adjusts the amount of light incident on the image sensor 110. The diaphragm 260 is driven by the diaphragm driver 261, and the size of the opening is controlled. The diaphragm driver 261 includes a motor or an actuator.

The focus lens 210 is a lens for changing a focus state of a subject image incident from the optical system and formed on the image sensor 110. The lens configuration of the focus lens 210 may be any number of lenses or any number of groups. The focus lens driver 211 drives the focus lens 210 to move forward and backward along the optical axis of the optical system on the basis of the control of the lens controller 230. The focus lens driver 211 can be realized by, for example, a stepping motor, a DC motor, an ultrasonic motor, or the like.

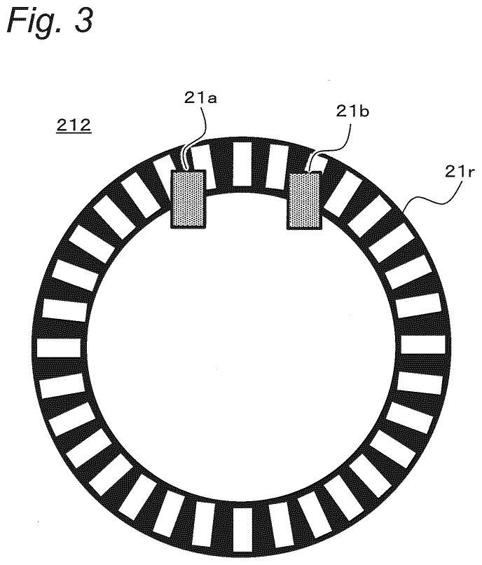

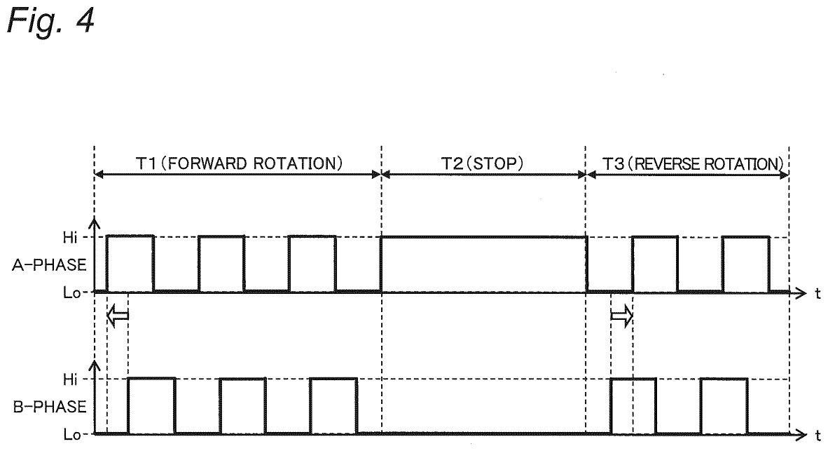

The MF ring 212 is an operation member provided for adjusting the focus position of the digital camera 1 by changing the position of the focus lens 210 along the optical axis in the interchangeable lens 200. The MF ring 212 will be described in detail with reference to FIGS. 3 and 4.

### 1-2-1. MF Ring

FIG. 3 illustrates a configuration of the MF ring 212 in the interchangeable lens 200 of the digital camera 1. For example, the MF ring 212 includes a ring member 21r provided along the outer periphery around the optical axis of the interchangeable lens 200, an A-phase photointerrupter 21a, and a B-phase photointerrupter 21b.

For example, as illustrated in FIG. 3, the ring member 21r is provided with a plurality of slits periodically in the circumferential direction, thereby forming periodic light shielding portions and light transmitting portions. The ring member 21r of the MF ring 212 is configured to be rotatable without limitation of an angular range, for example. Alternatively, the ring member 21r may be configured to be rotatable within a predetermined angular range.

The A-phase photointerrupter 21a and the B-phase photointerrupter 21b are disposed at positions having a phase shift of ¼ cycle from each other in the arrangement cycle of the slits in the ring member 21r (see FIG. 4). Each of the photointerrupters 21a and 21b includes a light emitter and a light receiver that face each other via the ring member 21r. Each of the photointerrupters 21a and 21b generates a detection signal by receiving light from the light emitting unit by the light receiver, and outputs the detection signal to the lens controller 230.

FIG. 4 is a timing chart illustrating a detection signal of the MF ring 212 in the interchangeable lens 200. FIG. 4 illustrates the timing of the detection signal from the A-phase photointerrupter 21a and the timing of the detection signal from the B-phase photointerrupter 21b in the MF ring 212. FIG. 4 illustrates each detection signal when the MF ring 212 is rotated in the forward direction (e.g., clockwise) in a period T1, stopped in a period T2, and rotated in the reverse direction (e.g., counterclockwise) in a period T3.

For example, the detection signal of the MF ring 212 has a signal level such as a high level Hi or a low level Lo, as illustrated in FIG. 4. The high level Hi of the detection signal indicates a state in which the corresponding photointerrupters 21a and 21b face the light transmitting portion of the ring member 21r, and the low level Lo indicates a state in which the corresponding photointerrupters 21a and 21b face the light shielding portion of the ring member 21r.

For example, as illustrated in FIG. 4, in the period T1 with the MF ring 212 rotating forward, the pulse waveform of the detection signal is formed with the phase in which the A phase precedes by ¼ cycle. In the period T2 with the MF ring 212 being stopped, the signal level of each detection signal is constant. In the period T3 with the MF ring 212 rotating in the reverse direction, a pulse waveform of the detection signal is formed with a phase in which the B-phase precedes reversely to the period T1. Based on such a detection signal of the MF ring 212, the lens controller 230 can detect various rotation states of the MF ring 212.

For example, the lens controller 230 counts the number of pulses in the detection signal of the MF ring 212 with the forward rotation as positive and the reverse rotation as negative. With such a counting result, the rotational position of the MF ring 212 can be detected. For example, in the MF mode, the lens controller 230 controls the focus lens driver 211 to drive the focus lens 210 according to the counted number of pulses. According to such an MF function, a focus position of the digital camera 1 can be adjusted according to a degree of an operation of the MF ring 212 by a user.

### 2. Operation

The operation of the digital camera 1 configured as described above will be described below.

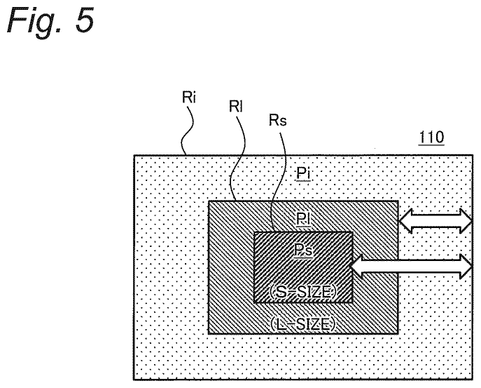

A basic operation of the electronic zoom function by the digital camera 1 of the present embodiment will be described with reference to FIG. 5.

FIG. 5 is a diagram for explaining an electronic zoom function in the digital camera 1. The digital camera 1 of the present embodiment can set the size of the image for a shooting result selectively by a user operation with the user interface 150 on the setting menu, separately from the setting of the electronic zoom function, for example. For example, the digital camera 1 presents an L size option having a relatively large image size or an S size option having a relatively small image size to the user in a selectable manner.

FIG. 5 illustrates a relation among an entire range Ri in which pixels are two-dimensionally arranged in the image sensor 110, an L-size image range Rl, and an S-size image range Rs. For example, as illustrated in FIG. 5, each image size in the digital camera 1 has a number of pixels Pl and Ps defined to be not more than the number of pixels Pi in the entire range Ri in the image sensor 110.

For example, the digital camera 1 of the present embodiment realizes the electronic zoom function using a difference between the number of pixels Pi of the entire range Ri of the image sensor 110 and the number of pixels Pl and Ps of each image size. For example, the digital camera 1 of the present embodiment sets the maximum value (referred to as “Mx”) of the electronic zoom magnification (referred to as “M”) according to the image size selected by the user, and the maximum value Mx can be increased as the image size is smaller.

For example, supposing that the number of pixels Pi of the image sensor 110 is 4096 pixels in the horizontal direction out of the horizontal direction and the vertical direction in the digital camera 1, the number of pixels Pl of the L size can be defined as 2048 pixels in the horizontal direction, and the number of pixels Ps of the S size can be defined as 1024 pixels in the horizontal direction. In this example, the maximum value Mx of the electronic zoom magnification Mis Mx=2.0 times in the case of the L size, and Mx=4 times in the case of the S size.

For the electronic zoom operation of the digital camera 1 in the present embodiment, the zoom processor 145 crops an image of an area smaller by the electronic zoom magnification M from the entire range Ri of the image sensor 110 according to the electronic zoom magnification M set by the user operation. Furthermore, the zoom processor 145 performs resolution conversion processing of reducing the number of pixels of the cropped image to the number of pixels Pl and Ps of the selected image size, and generates image data of an electronic zoom result.

For example, when the electronic zoom magnification Mis 1 time, an image in the entire range Ri of the image sensor 110 is used as a cropped image. When the electronic zoom magnification M is the maximum value Mx, images of the image ranges Rl and Rs themselves each having the selected image size can be used as cropped images. In this case, the resolution conversion processing can be omitted.

According to the electronic zoom operation described above, the image cropping by the zoom processor 145 is performed within a range between the entire range Ri of the image sensor 110 and the image ranges RI and Rs of the selected image size. As a result, the digital camera 1 of the present embodiment can keep the number of pixels of the image size in the image cropping by the electronic zoom operation, and can avoid deterioration in image quality.

For example, in the case where deterioration in image quality due to cropping of an image is allowable in the digital camera 1, the maximum value Mx of the electronic zoom magnification M may be set to be larger than that in the above example according to the allowable range. In this case, when cropping an image in a region smaller than the image ranges RI and Rs according to the electronic zoom magnification M, the zoom processor 145 increases the number of pixels of the cropped image to the number of pixels Pl and Ps of the image size by interpolation or the like in the resolution conversion processing, for example.

In the digital camera 1 of the present embodiment, the electronic zoom function can be allocated to the operation member of the interchangeable lens 200, so that the user can easily use the electronic zoom. Details of the operation of the digital camera 1 of the present embodiment will be described below.

### 2-1. Initial Communication Operation

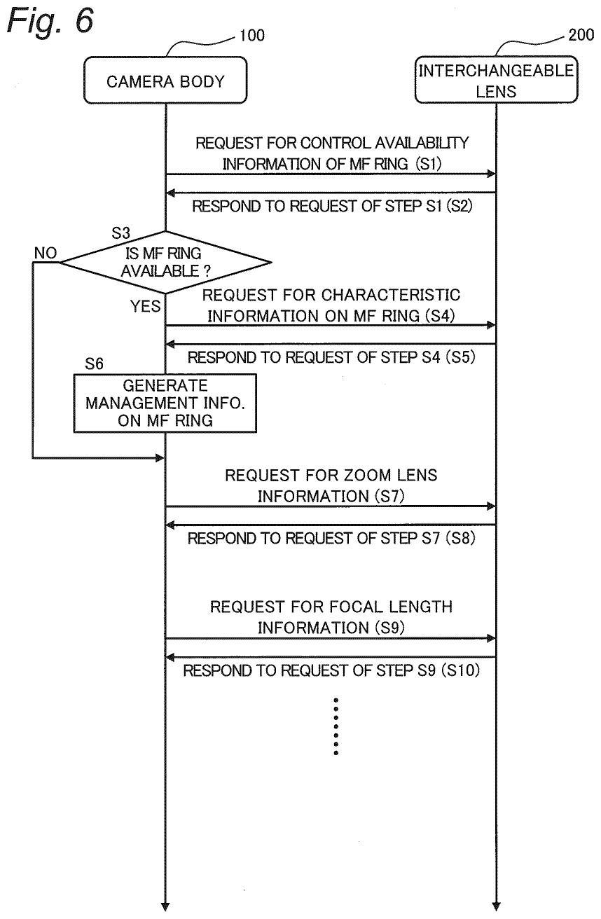

In the digital camera 1 of the present embodiment, the camera body 100 and the interchangeable lens 200 perform data communication for preparation of various operations, for example, in an initial state such as when the interchangeable lens 200 is attached or when the camera body 100 is powered on. The initial communication operation of the present embodiment will be described with reference to FIG. 6.

FIG. 6 is a sequence diagram illustrating an initial communication operation in the digital camera 1. The processing illustrated in FIG. 6 is started with the interchangeable lens 200 attached to the camera body 100 and power supplied from the camera body 100 to the interchangeable lens 200.

In the digital camera 1 of the present embodiment, the camera controller 140 of the camera body 100 requests the interchangeable lens 200 for control availability information of the MF ring 212 via the body mount 160 (S1). For example, the control availability information indicates whether control for allocating an electronic zoom function to a corresponding operation member in the interchangeable lens 200 is available.

The interchangeable lens 200 responds to the request for the control availability information of the MF ring 212 from the camera body 100 (S2). For example, referring to lens data stored in advance in the flash memory 232, in the interchangeable lens 200, the lens controller 230 acquires control availability information of the MF ring 212, and transmits the acquired control availability information to the camera body 100 via the lens mount 250 (S2).

For example, the camera controller 140 determines whether the electronic zoom function can be allocated to the MF ring 212 of the interchangeable lens 200, based on the control availability information (S2) of the MF ring 212 received from the interchangeable lens 200 (S3). For example, when the interchangeable lens 200 can disallow the focus adjustment operation according to the operation of the MF ring 212 and can notify the camera body 100 of the operation amount such as the number of pulses of the MF ring 212, the determination in step S3 is “YES”, and otherwise, “NO”.

When determining that the electronic zoom function can be allocated to the MF ring 212 of the interchangeable lens 200 (YES in S3), the camera controller 140 requests the characteristic information of the MF ring 212 from the interchangeable lens 200, for example (S4). For example, the characteristic information of the MF ring 212 includes the number of pulses output when the MF ring 212 is rotated by a predetermined range (e.g., one turn).

In response to the request in step S4, the lens controller 230 of the interchangeable lens 200 transmits the characteristic information of the MF ring 212 stored in advance in the flash memory 232 to the camera body 100 via the lens mount 250, for example (S5).

The camera controller 140 generates management information on an operation of the MF ring 212, based on the characteristic information on the MF ring 212 received from the interchangeable lens 200 via the body mount 160, and the setting information on the image size selected in advance in the camera body 100 (S6). The management information manages a correspondence between an operation amount of the MF ring 212 and the electronic zoom magnification M, and includes, e.g. a changing rate of the electronic zoom magnification M with respect to an operation amount (e.g., several pulses) of a predetermined pitch.

For example, in step S6, the camera controller 140 calculates a fluctuation rate for continuously changing the electronic zoom magnification M in setting ranges 1 to Mx in a predetermined angular range (e.g., 120 degrees) of the MF ring 212. For example, the camera controller 140 stores the management information of the MF ring 212 obtained from a calculation result in the RAM 141.

On the other hand, when determining that the electronic zoom function cannot be allocated to the MF ring 212 of the interchangeable lens 200 (NO in S3), the camera controller 140 proceeds to step S7 without performing the processing of steps S4 and S6, for example.

The camera controller 140 of the camera body 100 requests zoom lens information from the interchangeable lens 200 via the body mount 160 (S7). The zoom lens information includes information indicating whether the interchangeable lens 200 includes an optical zoom mechanism and information indicating whether the interchangeable lens 200 includes the zoom ring 222.

In response to the request in step S7, the lens controller 230 of the interchangeable lens 200 transmits zoom lens information to the camera body 100 via the lens mount 250 (S8), wherein the zoom lens information is stored in advance in the flash memory 232, for example.

Furthermore, the camera controller 140 requests the interchangeable lens 200 for focal length information (S9). In response to the request in step S9, the lens controller 230 transmits focal length information stored to the camera body 100 (S10), wherein the focal length information is stored in advance in the flash memory 232, for example. For example, when the interchangeable lens 200 has an optical zoom mechanism, the focal length information includes a maximum value and a minimum value of the focal length of the interchangeable lens 200. When the interchangeable lens 200 is a single focal length lens, the focal length information indicates one focal length of the interchangeable lens 200.

According to the initial communication operation described above, in the digital camera 1 of the present embodiment, the camera body 100 can acquire various information for allocating the electronic zoom function to the operation member of the attached interchangeable lens 200, and prepare for the allocation of the electronic zoom function. For example, the management information (S6) of the MF ring 212 is referred to during the electronic zoom operation using the MF ring 212. In the first embodiment, the interchangeable lens 200 in which the MF ring 212 can be controlled for the allocation will be described.

The initial communication operation of the digital camera 1 is not limited to the above example, and for example, the camera controller 140 may request control availability information for various operation members in the interchangeable lens 200 similarly to step S1. In response to a request for control availability information from the camera body 100, the lens controller 230 of the interchangeable lens 200 may transmit information indicating an operation member that can be controlled for assignment of the electronic zoom function to the camera body 100 similarly to step S2. When the interchangeable lens 200 includes an operation member that can be controlled for the above-described allocation, the camera controller 140 may generate management information of the operation member, for example, similarly to step S6.

Furthermore, the zoom lens information in steps S7 and S8 described above may include whether the optical zoom mechanism of the interchangeable lens 200 is mechanical or electric, and whether or not the optical zoom mechanism includes an operation member (e.g., a zoom lever) different from the zoom ring 222. In the first embodiment, a case where the interchangeable lens 200 includes a mechanical optical zoom mechanism by the zoom ring 222 will be described.

### 2-2. Electronic Zoom Setting Processing

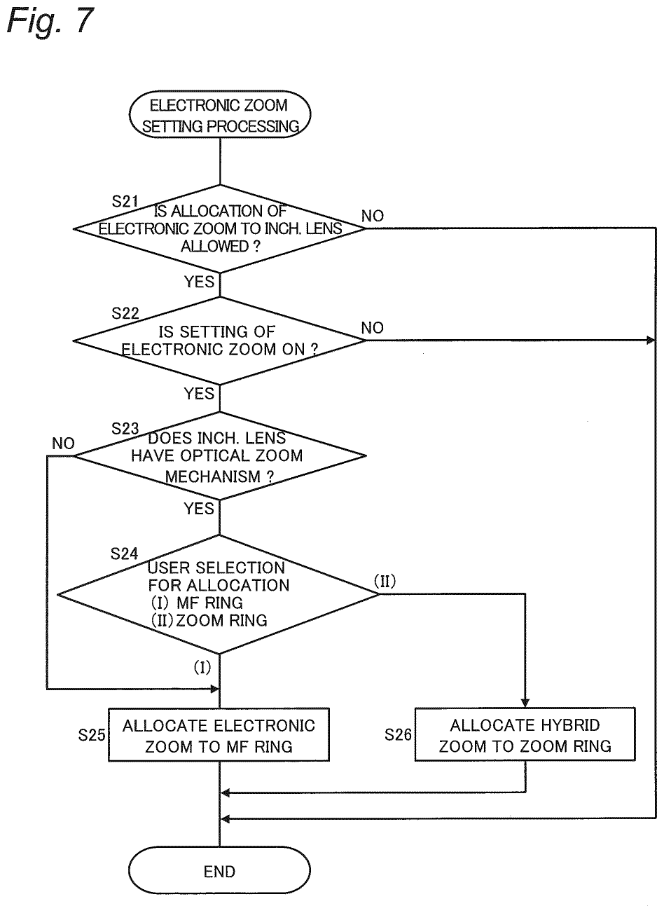

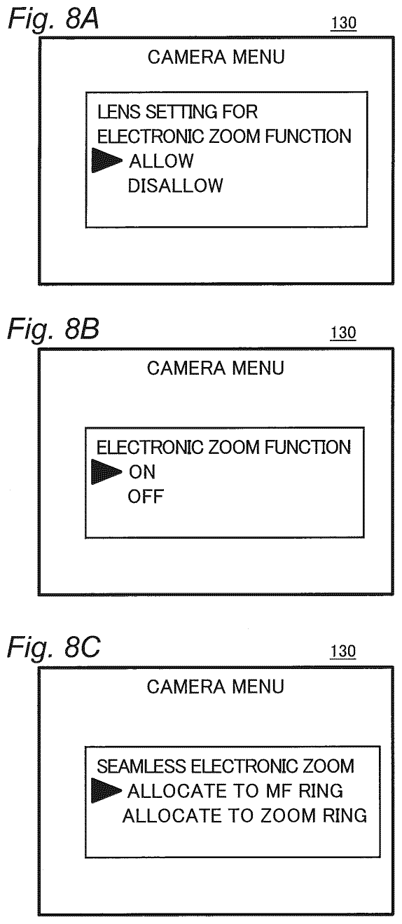

Setting processing of allocating the electronic zoom function to the operation member of the interchangeable lens 200 in response to the user operation after the initial communication operation (FIG. 6) is performed in the digital camera 1 of the present embodiment will be described with reference to FIGS. 7 to 8C.

FIG. 7 is a flowchart illustrating electronic zoom setting processing in the digital camera 1 of the present embodiment. FIGS. 8A to 8C illustrate a display example of a setting menu according to the present embodiment. For example, the processing illustrated in the flow of FIG. 7 is started in response to an operation of the setting menu of the digital camera 1 by the user. The processing exemplified in this flow is executed by the camera controller 140 of the camera body 100 in the digital camera 1, for example.

In the camera body 100, the camera controller 140 determines whether the allocation of the electronic zoom function to the operation member in the interchangeable lens 200 is allowed in the current menu setting of the digital camera 1, for example (S21). A display example of step S21 is illustrated in FIG. 8A.

FIG. 8A illustrates a menu screen of function allocation to the interchangeable lens 200 in the digital camera 1. In step S21, the camera controller 140 receives, by the user interface 150, a user operation of selecting an option of “allow” or “disallow” of the allocation of the electronic zoom function to the interchangeable lens 200 on the menu screen of the example of FIG. 8A displayed on the display monitor 130, for example.

When the option of “disallow” is selected by the user operation on the menu screen of FIG. 8A, the camera controller 140 determines that the allocation of the electronic zoom function in the interchangeable lens 200 is not allowed (NO in S21). In this case, the camera controller 140 ends the processing of this flow, for example.

On the other hand, when the option of “allow” is selected by the user operation on the menu screen of FIG. 8A, the camera controller 140 determines that the allocation of the electronic zoom function in the interchangeable lens 200 is allowed (YES in S21). In this case, the camera controller 140 determines whether the allocation setting of the electronic zoom function is enabled in the further menu setting, for example (S22). A display example of step S22 is illustrated in FIG. 8B.

FIG. 8B illustrates a menu screen of allocation setting of the electronic zoom function in the digital camera 1. In step S22, the camera controller 140 displays the menu screen of the example of FIG. 8B on the display monitor 130, to receive a user operation of selecting an option of “ON (enable)” or “OFF (disable)” of the electronic zoom function on the screen by the user interface 150, for example (S22).

When the option of “OFF” is selected on the menu screen of FIG. 8B, the camera controller 140 determines that the allocation setting of the electronic zoom function is not enabled (NO in S22), and ends the processing of this flow, for example.

On the other hand, when the option of “ON” is selected on the menu screen of FIG. 8B, the camera controller 140 determines that the allocation setting of the electronic zoom function is enabled (YES in S22). In this case, the camera controller 140 performs processing for selecting an operation member to which the electronic zoom function is allocated in the operation member of the interchangeable lens 200 (S23 to S26).

For example, in the digital camera 1 of the present embodiment, the camera controller 140 determines whether or not the interchangeable lens 200 attached to the camera body 100 includes the optical zoom mechanism, based on the zoom lens information (S8 in FIG. 6) received from the interchangeable lens 200 (S23). A display example in the case where the interchangeable lens 200 includes the optical zoom mechanism (YES in S23) is illustrated in FIG. 8C.

FIG. 8C illustrates an allocation destination selection screen in the case where the interchangeable lens 200 attached to the digital camera 1 includes a mechanical optical zoom mechanism (see FIG. 1). The display monitor 130 of the digital camera 1 displays an option of allocating the electronic zoom function to the MF ring 212 and an option of allocating the electronic zoom function to zoom ring 222 on the selection screen illustrated in FIG. 8C.

For example, with the selection screen of FIG. 8C being displayed on the display monitor 130, the camera controller 140 receives, on the user interface 150, a user operation of selecting either (I) the option of the MF ring 212 or (II) the option of the zoom ring 222 (S24). For example, each option can be selected by a user operation of the direction button 152 on the user interface 150 of the camera body 100 or the touch panel 155.

In the digital camera 1 of the present embodiment, when a user operation for selecting an option of the MF ring 212 is input on the selection screen of FIG. 8C ((I) of S 24), the camera controller 140 allocates the electronic zoom function to the MF ring 212, for example (S25). In this case, for example, when the digital camera 1 is set to the AF mode in the focus selection lever 153 (FIG. 2), the digital camera 1 of the present embodiment sets the electronic zoom function in the MF ring 212 instead of the MF function (details will be described later).

On the other hand, when a user operation of selecting an option of the zoom ring 222 is input on the selection screen illustrated in FIG. 8C ((II) in S24), the camera controller 140 allocates the hybrid zoom function to the zoom ring 222 (S26). The hybrid zoom function is a function of performing optical zoom and electronic zoom in conjunction with each other.

In this example, as the optical zoom mechanism of the interchangeable lens 200 is mechanical, a hybrid zoom function is allocated to the zoom ring 222 instead of the electronic zoom function (S26). According to the hybrid zoom function, the substantial zoom magnification of the digital camera 1 can be expanded by the electronic zoom magnification M from the magnification of the optical zoom (details will be described later).

In the case where the interchangeable lens 200 does not include the optical zoom mechanism (NO in S23), the camera controller 140 allocates an electronic zoom function to the MF ring 212, for example (S25). In this case, the selection screen of FIG. 8C may not be displayed, or may be grayed out as operation disablement.

The camera controller 140 ends the processing illustrated in the flow of FIG. 7 by allocating functions (S25, S26) to the MF ring 212 or the zoom ring 222, for example.

According to the electronic zoom setting processing (FIG. 7) described above, the digital camera 1 of the present embodiment allocates the electronic zoom function to the MF ring 212 in the interchangeable lens 200, for example (S25). By allocating the electronic zoom function to the MF ring 212, The digital camera 1 of the present embodiment can utilize the MF ring 212 that is not normally used in the AF mode, and can facilitate the user to use the continuous electronic zoom.

According to the allocation of the electronic zoom function (S25), the digital camera 1 of the present embodiment can facilitate to use the electronic zoom function also in view that the MF ring 212 is provided in a wide variety of interchangeable lenses 200. For example, even if the interchangeable lens 200 is a single focal length lens having no optical zoom function (NO in S24), the electronic zoom function can be allocated by utilizing the MF ring 212 of the interchangeable lens 200.

Furthermore, in the case where the interchangeable lens 200 attached to the camera body 100 includes an optical zoom mechanism (YES in S23), the digital camera 1 of the present embodiment can allocate functions to the zoom ring 222 in addition to the MF ring 212 (S26). With such a plurality of options, the electronic zoom function can be easily utilized.

For example, according to the allocation to the zoom ring 222 (S26), the user can operate the optical zoom and the electronic zoom in conjunction with each other. On the other hand, according to the allocation to the MF ring 212 (S25), the user can separately operate the optical zoom and the electronic zoom. For example, in the interchangeable lens 200, the electronic zoom can be used when the optical zoom changes the brightness, or the optical zoom can be used when having concern about a reduction in the image quality of the electronic zoom. According to the electronic zoom function allocated to the MF ring 212, the user can precisely control the electronic zoom magnification M by rotating the MF ring 121, and can easily use the electronic zoom.

In the digital camera 1 of the present embodiment, the electronic zoom function may be executed not only by the operation member of the interchangeable lens 200 but also by the user interface 150 (e.g., the touch panel 155 or the direction button 152) of the camera body 100. For example, even in the case of NO in step S21 or S22 described above, the electronic zoom function may be executable by the user interface 150 of the camera body 100. Alternatively, in the case of NO in step S22, the electronic zoom function may not be executable even in the user interface 150 of the camera body 100.

In the digital camera 1 of the present embodiment, steps S21 and S22 in the electronic zoom setting processing (FIG. 7) are not essential, and either one or both may be omitted. The order of the processing in steps S21 and S22 is not particularly limited, and may be the order opposite to the illustrated order.

In the above description, the example in which the management information of the MF ring 212 is performed in step S6 of the initial communication operation (FIG. 6) has been described. The management information of the MF ring 212 may be generated in the electronic zoom setting processing (FIG. 7), and may be after allocation to the MF ring 212 (S25).

### 2-3. Electronic Zoom Operation

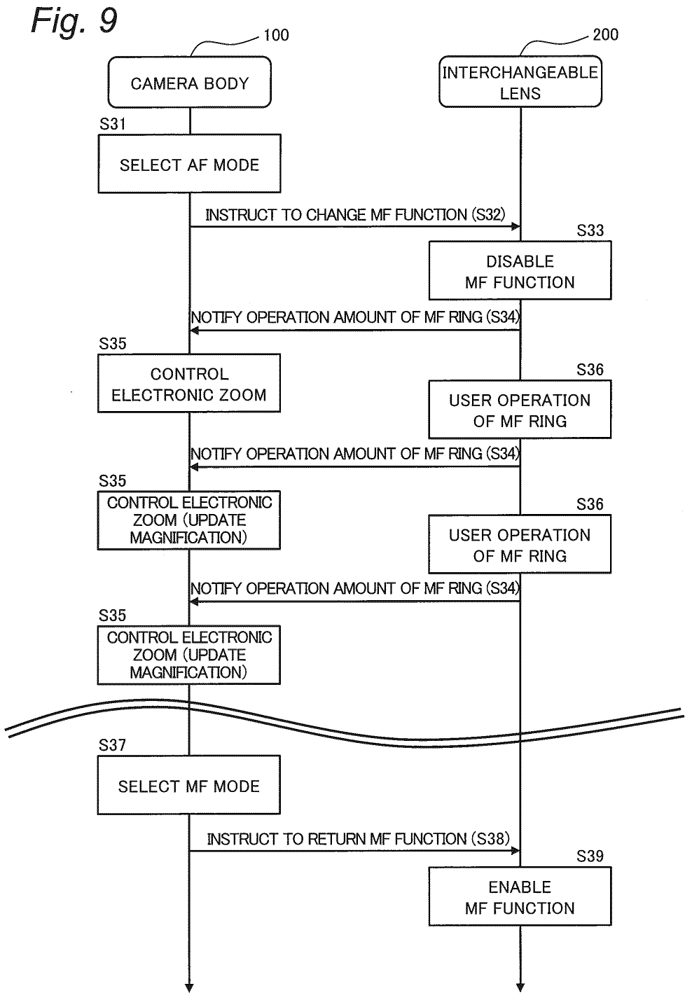

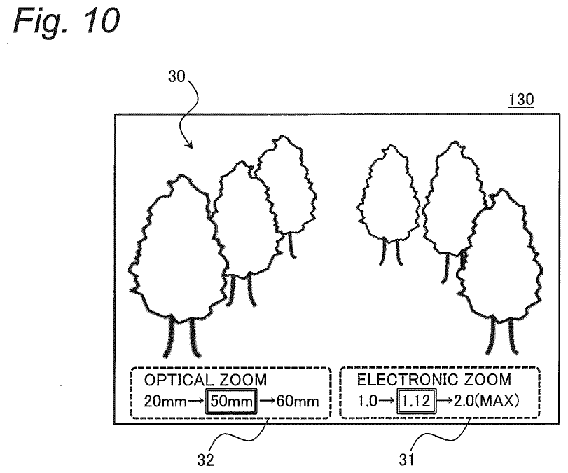

An operation of electronic zoom in a case where the electronic zoom setting processing (FIG. 7) allocates the electronic zoom function to the MF ring 212 (S25) in the digital camera 1 of the present embodiment will be described with reference to FIGS. 9 to 10.

FIG. 9 is a sequence diagram illustrating an electronic zoom operation in the digital camera 1 of the present embodiment. FIG. 9 illustrates an operation example in a case where the AF mode is first selected by the focus selection lever 153 of the digital camera 1 and then the MF mode is selected, for example.

First, in the camera body 100 of the digital camera 1, the camera controller 140 sets the digital camera 1 to the AF mode in response to a user operation of selecting the AF mode with the focus selection lever 153, for example (S31). For example, the camera controller 140 performs various settings for the digital camera 1 to operate in the AF mode on the camera body 100, and instructs the interchangeable lens 200 to execute the AF operation.

For example, the camera controller 140 instructs the interchangeable lens 200 via the body mount 160 to change the function of the MF ring 212 from the MF function in which the operation of manually adjusting the focus is performed (S32). For example, the instruction to change the MF function (S32) includes an instruction to disable the MF function and an instruction to respond to an operation amount of the MF ring 212. Such an instruction may be included in the instruction to start the AF operation and transmitted from the camera body 100 to the interchangeable lens 200.

In the interchangeable lens 200, when receiving the instruction to change the MF function (S32) from the camera body 100 via the lens mount 250, the lens controller 230 disables the MF function (S33). That is, the lens controller 230 disallows the focus adjustment operation of driving the focus lens 210 in response to the user operation of the MF ring 212 (S33).

In response to the instruction to change the function of the MF ring 212 (S32), the lens controller 230 in turn transmits a notification indicating an operation amount of the MF ring 212 to the camera body 100 via the lens mount 250 (S34). For example, the lens controller 230 sequentially counts the number of pulses as an example of the operation amount of the MF ring 212, and issues, in a predetermined communication cycle (e.g., 1/60 seconds), an operation amount notification indicating the number of pulses of the MF ring 212 (S34).

The operation amount notification (S34) of the MF ring 212 can be included in data communication periodically performed between the camera body 100 and the interchangeable lens 200 in the digital camera 1, for example. For example, when the MF ring 212 is not particularly operated, the lens controller 230 issues an operation amount notification of the number of pulses “0” (e.g., first S34).

For example, the camera controller 140 in turn receives notification of the operation amount of the MF ring 212 from the interchangeable lens 200 via the body mount 160 (S34), and functions as the zoom processor 145. The camera controller 140 as the zoom processor 145 controls the electronic zoom processing so as to continuously change the electronic zoom magnification M according to the operation amount of the received notification (S35).

For example, in step S35, first, referring to the management information of the MF ring 212 stored in the RAM141 in advance, the camera controller 140 calculates the electronic zoom magnification M corresponding to the received number of pitches. When the newly calculated electronic zoom magnification M is changed from the electronic zoom magnification being set in the zoom processor 145, the camera controller 140 causes the zoom processor 145 to perform the electronic zoom processing so as to update the electronic zoom magnification being set to the new electronic zoom magnification M.

Accordingly, when the MF ring 212 is operated by the user in the interchangeable lens 200 (S36), an operation amount according to the user operation is notified from the interchangeable lens 200 to the camera body 100 (S34), and electronic zoom processing of the electronic zoom magnification M according to the operation amount is performed (S35). A display example at the time of such electronic zoom control (S35) is illustrated in FIG. 10.

FIG. 10 illustrates a live view screen in the electronic zoom operation of the digital camera 1 in the present embodiment. In the present example, as illustrated in FIG. 10, the display monitor 130 displays a live view image 30, an electronic zoom indicator 31, and an optical zoom indicator 32, for example.

In the example of FIG. 10, the electronic zoom indicator 31 includes a minimum value “1.0 (times)”, a current value “1.12 (times)”, and a maximum value “2.0 (times)” of the electronic zoom magnification M. The optical zoom indicator 32 includes a minimum value “20 mm”, a current value “50 mm”, and a maximum value “60 mm” of the focal length of the optical zoom by the interchangeable lens 200.

In the digital camera 1 of the present embodiment, in step S35 for example, the camera controller 140 sequentially updates the current value of the electronic zoom magnification M in the electronic zoom indicator 31 so as to reflect the calculation result of the electronic zoom magnification M, and causes the display monitor 130 to display the updated current value. The camera controller 140 can also update the optical zoom indicator 32 by sequentially acquiring the current focal length from the interchangeable lens 200. According to the indicators 31 and 32, the user can sequentially grasp how much the electronic zoom and the optical zoom can be performed, and the user can easily use the zoom functions together.

Returning to FIG. 9, for example, when the focus selection lever 153 is switched from the AF mode to the MF mode by the subsequent user operation, the camera controller 140 sets the digital camera 1 to the MF mode (S37).

At this time, the camera controller 140 instructs the interchangeable lens 200 to return the function of the MF ring 212 to the MF function via the body mount 160, for example (S38). For example, the instruction to return the MF function (S38) includes an instruction to enable the MF function and an instruction to stop the notification of the operation amount of the MF ring 212.

In the interchangeable lens 200, when receiving the instruction to return the MF function (S38) from the camera body 100 via the lens mount 250, the lens controller 230 enables the MF function (S39). In this way, the lens controller 230 controls the focus lens driver 211 to adjust the position of the focus lens 210 according to the operation amount of the MF ring 212 by the subsequent user operation.

According to the above processing, the digital camera 1 of the present embodiment can realize effective use of the MF ring 212 by executing the electronic zoom operation by the MF ring 212 in the AF mode, for example. At this time, the original MF function of the MF ring 212 is disallowed (S33), and the electronic zoom operation by the MF ring 212 can be realized without interfering with the MF function.

In steps S31 and S37 described above, an example in which the focus mode of the digital camera 1 such as the AF mode or the MF mode is selected by the focus selection lever 153 has been described. The selection of the operation mode is not particularly limited to the focus selection lever 153, and the focus mode may be selected by a user operation of the setting menu of the digital camera 1, for example. Also in this case, similarly to steps S31 to S39 described above, the digital camera 1 of the present embodiment can set the electronic zoom function or the MF function in the MF ring 212 according to the selected focus mode and execute each operation.

In the above description, the display example of the electronic zoom indicator 31 and the optical zoom indicator 32 has been described in FIG. 10. Each of the indicators 31 and 32 is not particularly limited to the above example, and for example, the optical zoom indicator 32 may display an optical zoom magnification obtained by converting the focal length into a magnification instead of the focal length. Each of the indicators 31 and 32 may display the relation between the setting range and the current value by graph display instead of numerical value display. When the interchangeable lens 200 is a single focal length lens, the display of the optical zoom indicator 32 is omitted.

### 2-4. Hybrid Zoom Operation

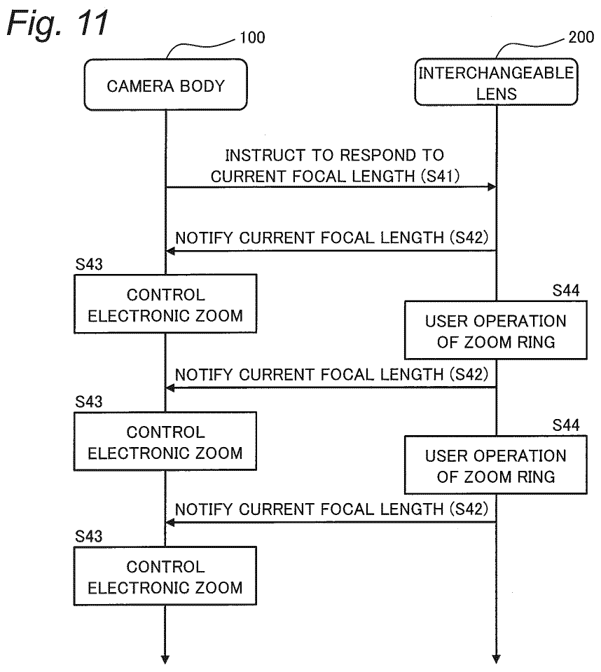

The hybrid zoom operation in the digital camera 1 of the present embodiment in the case where the electronic zoom setting processing (FIG. 7) allocates the hybrid zoom function to the zoom ring 222 (S26) will be described with reference to FIG. 11.

FIG. 11 is a sequence diagram illustrating a hybrid zoom operation in the digital camera 1 of the present embodiment. The processing illustrated in FIG. 11 is started with the management information indicating a correspondence between a focal length variable by the zoom ring 222 of the interchangeable lens 200 and the electronic zoom magnification M being stored in the RAM 141 or the like of the camera body 100, for example. Such management information of the zoom ring 222 can be generated by the camera controller 140 similarly to step S6, based on the focal length information (S10) received from the interchangeable lens 200 in the initial communication operation (FIG. 6) and the setting range of the electronic zoom magnification M.

First, in the camera body 100 of the digital camera 1, the camera controller 140 instructs the interchangeable lens 200 to respond in turn to the current focal length via the body mount 160, for example (S41). Such an instruction is not particularly limited to be transmitted after the allocation of the hybrid zoom function (S26 in FIG. 7), and may be transmitted from the camera body 100 to the interchangeable lens 200, for example, at the time of the initial communication operation (FIG. 6).

In the interchangeable lens 200, the lens controller 230 in turn transmits a notification indicating the current focal length to the camera body 100 via the lens mount 250 in response to the instruction to respond to the focal length (S41) from the camera body 100 (S42). For example, the lens controller 230 manages the focal length of the interchangeable lens 200 as needed, based on the output of the zoom lens position detection unit 223, to issue a focal length notification in a predetermined communication cycle (S42).

The camera controller 140, serving as the zoom processor 145 according to the focal length notification (S42) from the interchangeable lens 200, controls the electronic zoom processing so as to continuously change the electronic zoom magnification M according to the focal length of the received notification (S43).

For example, in step S43, the camera controller 140 first calculates the electronic zoom magnification M corresponding to the received focal length with reference to the management information of the zoom ring 222 stored in advance in the RAM 141. Similarly to the electronic zoom operation (S35 in FIG. 9), the camera controller 140 causes the zoom processor 145 to perform the electronic zoom processing so as to update the electronic zoom magnification M to a new electronic zoom magnification M.

Consequently, in the interchangeable lens 200, when the zoom ring 222 is operated by the user (S44), a new focal length is notified to the camera body 100 along with the progress of the optical zoom in which the zoom lens 220 is moved via the zoom lens drive mechanism 221 (S42). In this way, in conjunction with the optical zoom of the interchangeable lens 200, the electronic zoom processing of the electronic zoom magnification M according to the new focal length is performed in the camera body 100 (S43).

As described above, according to the hybrid zoom operation in the digital camera 1 of the present embodiment, the optical zoom mechanism of the interchangeable lens 200 and the electronic zoom processing of the camera body 100 are performed in conjunction with each other, and it is possible to realize a continuous zoom operation in which the range of the focal length is substantially expanded.

According to the digital camera 1 of the present embodiment, it is possible to provide options of allocating the electronic zoom function to the MF ring 212 and allocating the hybrid zoom function to the zoom ring 222 when the user uses the interchangeable lens 200 including the mechanical optical zoom mechanism, for example.

### 3. Review

As described above, in the digital camera 1 according to the present embodiment, the camera body 100 as an example of the imaging apparatus to which the interchangeable lens 200 is detachably attached includes the body mount 160 as an example of the communication interface, the image sensor 110 as an example of the image sensor, the camera controller 140 as an example of the controller, the zoom processor 145 as an example of the image processor, and the user interface 150 as an example of the setting interface. The body mount 160 performs data communication with the attached interchangeable lens 200. The image sensor 110 captures a subject image via the interchangeable lens 200 to generate image data. The camera controller 140 controls the operation of the interchangeable lens 200 by data communication via the body mount 160. The zoom processor 145 performs electronic zoom processing of cropping an image at the electronic zoom magnification M as an example of a variable magnification from the image data generated by the image sensor 110. In response to a user operation, the setting interface sets electronic zoom processing on the MF ring 212 as an example of a first operation member provided in the interchangeable lens 200 (S25, S31, see FIG. 8). When the electronic zoom processing is not set to the first operation member by the setting interface, the camera controller 140 causes the interchangeable lens 200 to perform a predetermined operation such as a focus adjustment operation of the MF function in response to the operation of the first operation member (S37 to S39). When the electronic zoom processing is set to the first operation member by the setting interface, the camera controller 140 disallows a predetermined operation by the interchangeable lens 200 and controls the zoom processor 145 to perform the electronic zoom processing in response to the operation of the first operation member (S31 to S35).

According to the camera body 100 of the digital camera 1 described above, when the electronic zoom processing is set to the operation member such as the MF ring 212 in the interchangeable lens 200, the predetermined operation of the operation member is disallowed, and the allocation of the electronic zoom function to the interchangeable lens 200 can be realized. As a result, the camera body 100 of the present embodiment can easily use the electronic zoom of the digital camera 1.

In the present embodiment, the MF ring 212 is provided so as to output an operation amount indicating a degree of operation by the user on the interchangeable lens 200 as a detection signal (see FIG. 4). When the electronic zoom processing is set to the MF ring 212 (S31), the camera controller 140 sequentially receives the operation amount of the MF ring 212 from the interchangeable lens 200 via the body mount 160 (S34), and controls the zoom processor 145 to perform the electronic zoom processing while changing the magnification according to the received operation amount (S35). As a result, in the digital camera 1 of the present embodiment, the camera body 100 can realize the electronic zoom operation in which the operation amount of the MF ring 212 of the interchangeable lens 200 is sequentially reflected in the electronic zoom magnification M, and the user can easily use the electronic zoom of the digital camera 1.

In the present embodiment, the camera controller 140 receives the characteristic information regarding the MF ring 212 from the attached interchangeable lens 200 via the body mount 160 (S4, S5), and manages the correspondence between the operation amount and the electronic zoom magnification M by, for example, generating the management information of the MF ring 212 on the basis of the characteristic information of the MF ring 212 and the range in which the electronic zoom magnification M can be set in the electronic zoom processing (S6). With such management of the correspondence, in the digital camera 1 of the present embodiment, the camera body 100 can realize the electronic zoom operation according to the operation of the MF ring 212 of the interchangeable lens 200, and the user can easily use the electronic zoom of the digital camera 1.

In the present embodiment, the setting interface of the camera body 100 includes the focus selection lever 153 as an example of the switcher that switches the operation mode of the camera body 100 among a plurality of operation modes including the MF mode as an example of the first operation mode corresponding to the focus adjustment operation of the MF function in response to a user operation. When the operation mode of the camera body 100 is switched to the MF mode by the focus selection lever 153, the setting interface does not set the electronic zoom processing to the MF ring 212 (S37 to S38). When the operation mode of the camera body 100 is switched to the AF mode as an example of the second operation mode different from the MF mode in the focus selection lever 153, the setting interface sets the electronic zoom processing to the MF ring 212 (S31 to S32). As a result, the electronic zoom function can be set to be available by switching the operation mode by the switcher such as the focus selection lever 153, and the user can easily use the electronic zoom of the digital camera 1.

In the present embodiment, the first operation member is provided to perform, as a predetermined operation, a focus adjustment operation of adjusting a focus position in the interchangeable lens 200 in response to a user operation. When the electronic zoom processing is set to the MF ring 212 by the setting interface, the camera controller 140 disallows the focus adjustment operation by the MF ring 212 (S31 to S32). As a result, interference between the original MF function of the MF ring 212 and the electronic zoom function can be avoided, and the electronic zoom of the digital camera 1 can be easily used.

In the present embodiment, the camera body 100 includes the display monitor 130 as an example of the display that displays at least one of an image and a menu screen. The interchangeable lens 200 includes the zoom lens 220 and the zoom ring 222 as an example of the second operation member for optical zooming by the zoom lens 220. The camera controller 140 causes the display monitor 130 to independently display the electronic zoom indicator 31 as an example of information indicating the magnification of the electronic zoom processing by the first operation member and the optical zoom indicator 32 as an example of information indicating the magnification of the optical zoom by the second operation member. For example, the electronic zoom indicator 31 is updated in response to the operation of the first operation member, and the optical zoom indicator 32 is updated in response to the operation of the second operation member. According to such a digital camera 1 of the present embodiment, the user can independently grasp the magnification of the electronic zoom processing and the magnification of the optical zoom, and can easily use various zoom functions. Each of the indicators 31 and 32 is not limited to the superimposed display on the live view image 30, and may be displayed on the menu screen, for example.

In the present embodiment, in a case where the interchangeable lens 200 includes the zoom lens 220 and the zoom ring 222 as an example of the second operation member for optical zoom by the zoom lens 220, the setting interface has a first option of allocating electronic zoom processing to the MF ring 212 and a second option of allocating electronic zoom processing together with optical zoom to the zoom ring 222 (SS24, see FIG. 8C). As a result, in the interchangeable lens 200 capable of performing the optical zoom, options using the optical zoom and the operation member are presented to the user, and various zoom functions of the digital camera 1 can be easily used by the user.

In the present embodiment, the interchangeable lens 200 detachably attachable to the camera body 100 includes the lens mount 250 as an example of the communication interface, the optical system (210,220,260), the MF ring 212 as an example of the operation member, and the lens controller 230 as an example of the controller. The lens mount 250 performs data communication with the attached camera body 100. The optical system forms an image on the image sensor 110 of the camera body 100. The MF ring 212 receives a operation of a user related to the optical system. The lens controller 230 controls an operation of the optical system according to an operation of the MF ring 212 on the basis of information received from the camera body 100 via the lens mount 250. When the electronic zoom processing of the camera body 100 is not set to the MF ring 212, the lens controller 230 performs a predetermined operation by the optical system in response to the operation of the MF ring 212 (S37 to S39), and when the electronic zoom processing is set to the MF ring 212, the lens controller 230 does not perform a predetermined operation by the optical system in response to the operation of the MF ring 212 (S31 to S33). As a result, the interchangeable lens 200 of the present embodiment can easily use the electronic zoom of the camera body 100.

In the interchangeable lens 200 of the present embodiment, an operation member such as the MF ring 212 is provided to output an operation amount indicating a degree of operation by the user in the interchangeable lens 200. When the electronic zoom processing is set for the operation member, the lens controller 230 transmits the operation amount of the operation member to the camera body 100 via the lens mount 250 (S31 to S34). As a result, in the interchangeable lens 200 of the present embodiment, the camera body 100 can reflect the operation amount of the operation member in the electronic zoom magnification M, and the user can easily use the electronic zoom of the digital camera 1.

### Second Embodiment

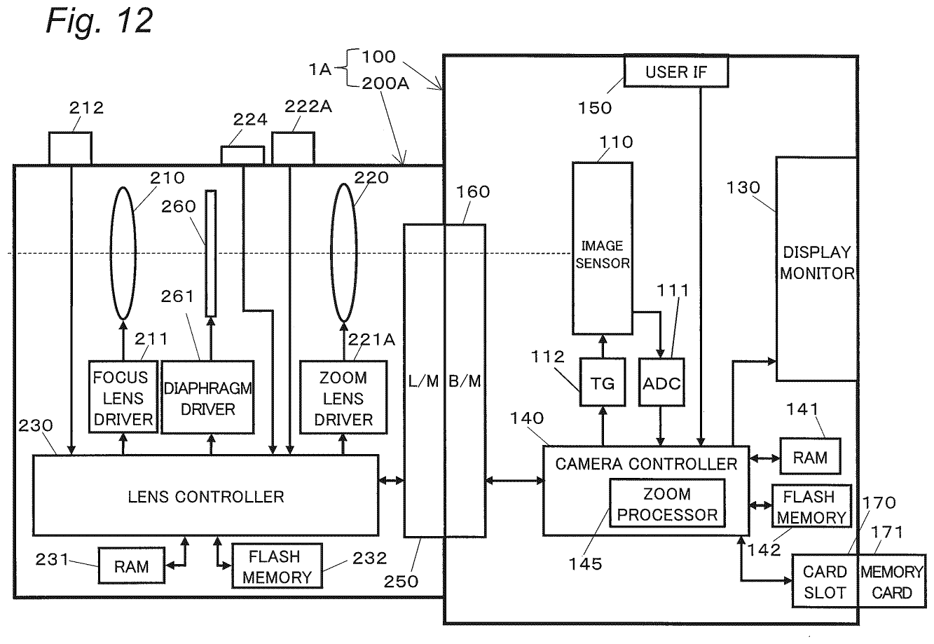

Hereinafter, a second embodiment of the present disclosure will be described with reference to FIGS. 12 to 15. In the first embodiment, the digital camera 1 in which the optical zoom mechanism is mechanical has been described. In the second embodiment, a digital camera 1A whose optical zoom mechanism is an electric type will be described.

Hereinafter, description of the configuration and operation similar to those of the digital camera 1 according to the first embodiment will be omitted as appropriate, and the digital camera 1A according to the present embodiment will be described.

### 1. Configuration

FIG. 12 illustrates a configuration of the digital camera 1A according to the second embodiment. For example, the digital camera 1A of the present embodiment has a configuration similar to that of the digital camera 1 (FIG. 1) of the first embodiment, and instead of the mechanical optical zoom mechanism (220 to 223), the digital camera 1A includes an interchangeable lens 200A provided with an electric optical zoom mechanism, as illustrated in FIG. 12. For example, the interchangeable lens 200A of the present embodiment includes, as an electric optical zoom mechanism, a zoom lens 220 similar to that of the first embodiment, an electric zoom lens driver 221A instead of the zoom lens drive mechanism 221, a zoom ring 222A, and a zoom lever 224.

In the interchangeable lens 200A of the present embodiment, the zoom lens driver 221A drives the zoom lens 220 to advance and retreat along the optical axis of the optical system on the basis of the control of the lens controller 230. The zoom lens driver 221A can be realized by a stepping motor, a DC motor, an ultrasonic motor, or the like, for example. The zoom lens driver 221A is an example of a driver that drives the zoom lens 220 to control optical zoom.

For example, the zoom ring 222A of the present embodiment can be configured by a ring member, a plurality of photointerrupters, and the like, similarly to the MF ring 212 (FIG. 3). For example, similarly to the MF ring 212, the zoom ring 222A generates a detection signal including a pulse waveform corresponding to the rotation operation, and outputs the detection signal to the lens controller 230 (see FIG. 4). For example, similarly to the MF ring 212, the lens controller 230 can count the number of pulses in the detection signal to detect the operation amount of the zoom ring 222A. The zoom ring 222A may be configured to be rotatable only within a predetermined angular range, or may be configured to be rotatable without limiting the angular range.

For example, the zoom lever 224 includes a lever member tiltable in two directions corresponding to a wide angle side and a telephoto side, and a potentiometer whose resistance value changes according to a degree of tilting of the lever member. For example, the zoom lever 224 outputs an output voltage of the potentiometer, which changes according to the degree of the tilt operation by the user, to the lens controller 230 as detection vibration. The lens controller 230 can detect the operation amount of the zoom lever 224 by performing analog/digital (A/D) conversion on the detection signal from the zoom lever 224, for example.

### 2. Operation

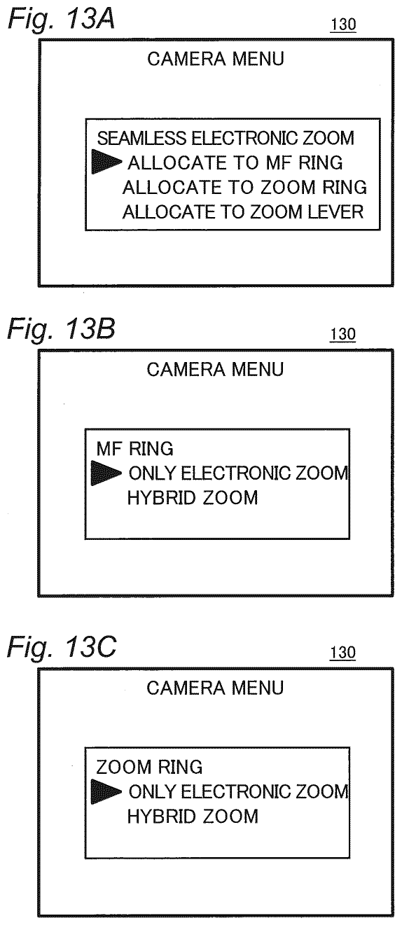

FIGS. 13A to 13C illustrate display examples of a setting menu in the digital camera 1A of the second embodiment. FIG. 13A illustrates an allocation destination selection screen in the digital camera 1A of the present embodiment.

For example, in the electronic zoom setting processing similar to that of the first embodiment, the digital camera 1A of the present embodiment accepts the user operation of the function allocation for the zoom lever 224 as illustrated in FIG. 13A, in addition to the MF ring 212 and the zoom ring 222A. For example, in the initial communication operation of the interchangeable lens 200A of the present embodiment similar to that of the first embodiment (S8 of FIG. 6), the zoom lens information transmitted to the camera body 100 includes information on the zoom lever 224 and the electric optical zoom mechanism.

FIG. 13B illustrates a function selection screen in the case where the MF ring 212 is selected in FIG. 13A. FIG. 13C illustrates a function selection screen in the case where the zoom ring 222A is selected in FIG. 13C.

In the digital camera 1A of the present embodiment, when any operation member is selected in FIG. 13A, the camera controller 140 causes the display monitor 130 to transition to the function selection screen as illustrated in FIGS. 13B and 13C, for example. In the function selection screen, the function to be allocated to the selected operation member includes an option of only the electronic zoom function and an option of the hybrid zoom function. In the case where the zoom lever 224 is selected, options similar to those in FIGS. 13B and 13C are included.

As described above, in the digital camera 1A of the present embodiment, the user interface 150 receives a user operation of selectively allocating either the electronic zoom function or the hybrid zoom function to various operation members of the interchangeable lens 200A using the electric optical zoom mechanism. For the zoom ring 222 and the zoom lever 224, the optical zoom function is allocated as a default when no user operation of the allocation described above.

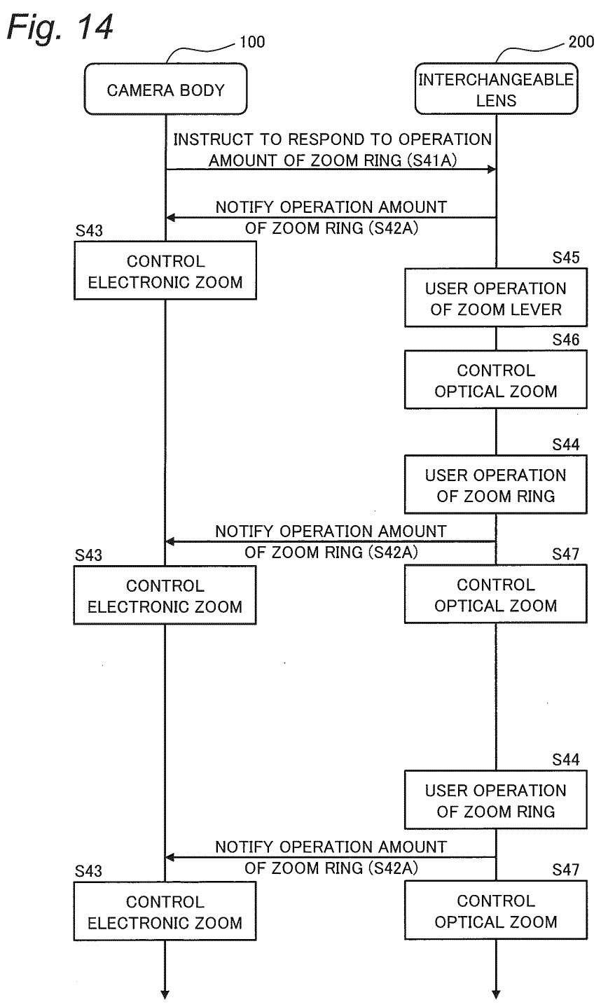

FIG. 14 illustrates a hybrid zoom operation in the digital camera 1A of the second embodiment. FIG. 14 illustrates an operation example in the case where the zoom lever 224 remains in the optical zoom function and the hybrid zoom function is allocated to the zoom ring 222.

In the present embodiment, instead of or in addition to the instruction to respond to the focal length (S41) in the hybrid zoom operation (FIG. 11) of the first embodiment, the camera body 100 transmits an instruction to respond to the operation amount of the zoom ring 222A to the interchangeable lens 200A, for example (S41A). In the present embodiment, responding to the instruction of step S41 (S41A), the interchangeable lens 200A in turn notifies the camera body 100 of the operation amount of the zoom ring 222A (S42A), instead of step S42 of FIG. 11, for example.

In the operation example of FIG. 14, when the zoom lever 224 is operated by the user (S45), the lens controller 230 of the interchangeable lens 200A drives the zoom lens driver 221A by the operation amount of the zoom lever 224, based on the detection signal from the zoom lever 224 (S46). Thus, optical zoom control of electrically moving the zoom lens 220 according to the operation amount of the zoom lever 224 is performed (S46). Although not illustrated in FIG. 14, the focal length of the interchangeable lens 200A can be notified to the camera body 100 as needed.

In the operation example of FIG. 14, when the zoom ring 222 is operated by the user (S44), the lens controller 230 of the interchangeable lens 200A drives the zoom lens driver 221A, based on the detection signal from the zoom ring 222 similarly to step S46 (S47).

At this time, the camera body 100 controls the electronic zoom processing by the operation amount of the zoom ring 222 similarly to the first embodiment, based on the operation amount notification (S42A) of the zoom ring 222 from the interchangeable lens 200A (S43). For performing such control, the camera controller 140 of the present embodiment prepares management information of the zoom ring 222 in advance so as to associate the operation amount of the zoom ring 222 with the electronic zoom magnification M. Thus, also in the digital camera 1A of the present embodiment, the hybrid zoom operation can be performed according to the operation amount of the zoom ring 222 or the like.

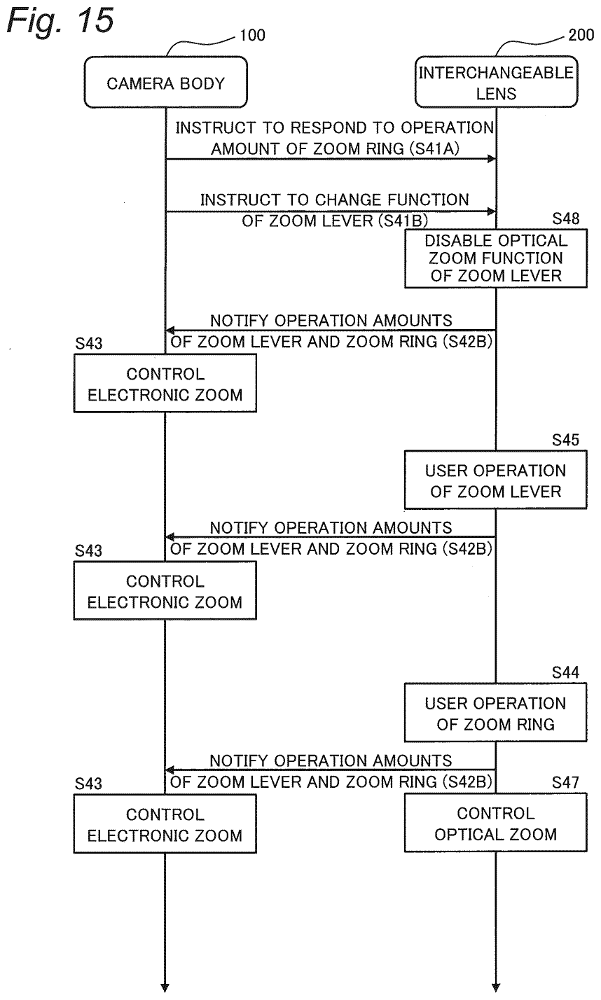

FIG. 15 illustrates an electronic zoom operation in the digital camera 1A of the second embodiment. FIG. 15 illustrates an operation example in the case where a change is made to allocate the electronic zoom function to the zoom lever 224 from the operation example of FIG. 14.

In the operation example of FIG. 15, in addition to the instruction of step S41A of the operation example of FIG. 14, the camera body 100 of the present embodiment transmits an instruction to change the function of the zoom lever 224 to the interchangeable lens 200A (S41B). The instruction to change the function includes an instruction to disable the optical zoom function by the zoom lever 224 and an instruction to respond to the operation amount of the zoom lever 224.

In response to the instruction to change the function (S41B) from the camera body 100, the lens controller 230 of the interchangeable lens 200A disables the optical zoom function by the zoom lever 224, that is, disallows the drive of the zoom lens driver 221A in response to the operation of the zoom lever 224 (S48).

In the operation example of FIG. 15, responding to the instruction of steps S41A and S41B, the lens controller 230 notifies the camera body 100 of the operation amount of the zoom lever 224 in addition to the operation amount of the zoom ring 222 (S42B), instead of step S42A of the operation example of FIG. 14.

In the operation example of FIG. 15, even if the zoom lever 224 is operated by the user (S45), the lens controller 230 of the interchangeable lens 200A does not perform the optical zoom control (S46 of FIG. 14) according to the disabled setting of step S48. At this time, the camera body 100 controls the electronic zoom processing by the operation amount of the zoom lever 224, based on the operation amount notification (S42B) from the interchangeable lens 200A (S43). In this way, the digital camera 1A of the present embodiment can realize the electronic zoom operation according to the operation amount of the zoom lever 224, for example.

The electronic zoom operation and the hybrid zoom operation in the digital camera 1A of the present embodiment as described above are not limited to the operation examples of FIGS. 14 and 15, and can be performed similarly to the above-described operation examples according to various allocations to the operation members. For example, in the case where the hybrid zoom function is allocated to the MF ring 212, in addition to the operation similar to that in FIG. 9, the lens controller 230 drives the zoom lens driver 221A according to the operation amount of the MF ring 212 to perform optical zoom control.

### 3 Review

As described above, in the digital camera 1A of the present embodiment, in a case where the interchangeable lens 200A further includes the zoom lens driver 221A as an example of the driver that drives the zoom lens 220 to control optical zoom, the setting interface of the camera body 100 further includes a third option of disallowing optical zoom and allocating electronic zoom processing to the zoom ring 221 A or the zoom lever 224 as an example of the second operation member (see FIG. 13B).

According to the digital camera 1A described above, in a case where the interchangeable lens 200A includes an electric optical zoom mechanism such as the zoom lens driver 221A, it is possible to provide the user with an option of disallowing optical zoom and to more easily use the electronic zoom function. Furthermore, in the present embodiment, the setting interface of the camera body 100 may further include a fourth option of allocating the electronic zoom processing together with the optical zoom to the first operation member such as the MF ring 212.

### Other Embodiments

As described above, the first and second embodiments have been described as examples of the technique disclosed in the present application. However, the technique in the present disclosure is not limited thereto, and can also be applied to embodiments in which changes, substitutions, additions, omissions, and the like are made as appropriate. In addition, it is also possible to combine each component described in each of the above-described embodiments to form a new embodiment. Thus, in the following, other preferred embodiments will be exemplified.

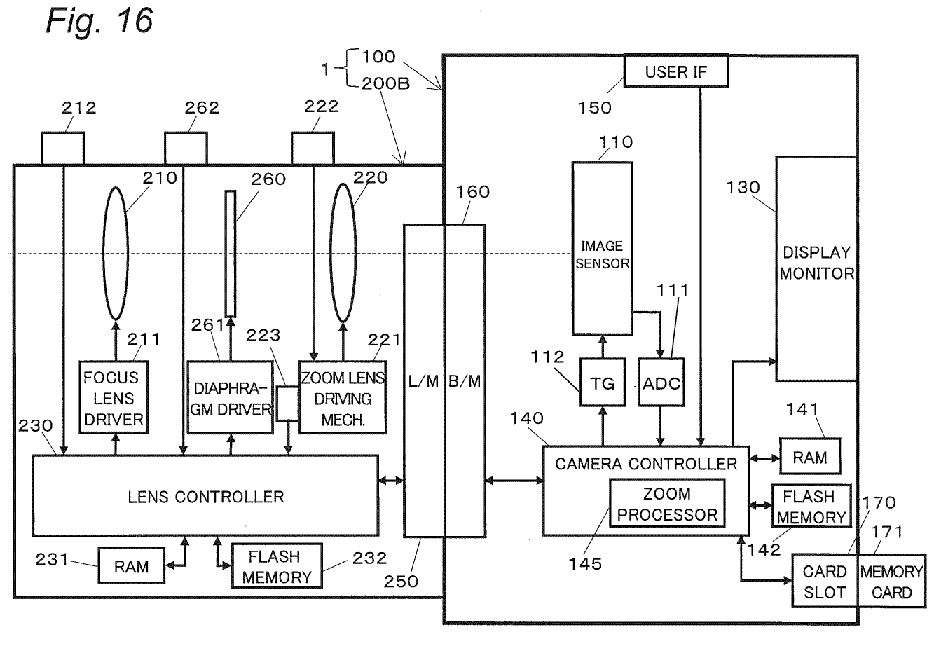

In the first and second embodiments, the example of the operation member to which the electronic zoom function is allocated in the interchangeable lens 200 of the digital camera 1 has been described, but the electronic zoom function may be allocated to various operation members other than the above example. Such a modification will be described with reference to FIG. 16.

FIG. 16 illustrates a configuration of a digital camera 1B of a modification of the first embodiment. In the present embodiment, the electronic zoom function of the digital camera 1B may be allocated to an operation member different from the MF ring 212 and the zoom ring 222 in the interchangeable lens 200B. For example, in the digital camera 1B of the present modification, the interchangeable lens 200B attached to the camera body 100 further includes a diaphragm ring 262 that receives a user operation for adjusting a diaphragm value of the diaphragm 260, in addition to the configuration similar to the interchangeable lens 200 of the first embodiment. In the digital camera 1B of the present embodiment, the camera controller 140 may allocate an electronic zoom function to such a diaphragm ring 262.

In the interchangeable lens 200B of the present modification, the diaphragm ring 262 includes, for example, a ring member and a potentiometer whose resistance value changes according to a rotational position of the ring member, and a diaphragm value corresponding to each rotational position is set in advance. The aperture ring 262 outputs, for example, an output voltage of a potentiometer that changes according to a rotational position of the ring member as a detection signal to the lens controller 230. For example, the lens controller 230 performs A/D conversion on the output voltage from the diaphragm ring 262, detects the rotational position of the diaphragm ring 262, and can specify the corresponding diaphragm value. For example, the lens controller 230 can perform an operation of controlling the diaphragm driver 261 to drive the diaphragm 260 according to the specified diaphragm value.

In the digital camera 1B of the present embodiment, for example, in the initial communication operation (FIG. 6) similar to each of the above embodiments, the camera controller 140 can request the interchangeable lens 200B for the control availability information of such a diaphragm ring 262, and can receive the minimum diaphragm value and the maximum diaphragm value from the interchangeable lens 200B. For example, the camera controller 140 can generate the management information indicating the correspondence between the aperture value and the electronic zoom magnification on the basis of the information received from the interchangeable lens 200B and the setting range of the electronic zoom magnification. For example, the camera controller 140 first calculates the number of diaphragm stages in a predetermined step (e.g., ⅓ or ½ step) on the basis of the minimum diaphragm value and the maximum diaphragm value of the interchangeable lens 200B. Next, the camera controller 140 can generate a table associating each diaphragm value in the number of diaphragm stages with the electronic zoom magnification in the setting range, for example, and store the table in the RAM 141 or the like as management information.

In the present embodiment, for example, when receiving a user operation of allocating an electronic zoom function to the diaphragm ring 262 in a setting menu or the like, the camera controller 140 transmits an instruction to change the function of the diaphragm ring 262 to the interchangeable lens 200 similarly to steps S22 and S41B. In response to this, the lens controller 230 of the interchangeable lens 200B disables the diaphragm adjustment function of the diaphragm ring 262, that is, disallows the operation of driving the diaphragm 260 in response to the user operation of the diaphragm ring 262. Furthermore, the lens controller 230 sequentially notifies the camera body 100 of the diaphragm value corresponding to the operation amount of the diaphragm ring 262. In this way, according to the diaphragm value notified from the interchangeable lens 200, the camera controller 140 can control the electronic zoom processing by the zoom processor 145 so as to update the electronic zoom magnification to the electronic zoom magnification corresponding to the received diaphragm value in the management information stored in advance.

In each of the above embodiments, an example has been described in which the notification of the operation amount and the like of various operation members such as the MF ring 212 (S34, S42, S42A, S42B) is performed in a predetermined communication cycle. In the digital camera 1 of the present embodiment, such an operation amount notification is not particularly limited to the above example, and may be performed as interrupt processing at the time when the operation member is operated. In the digital camera 1 of the present embodiment, the lens controller 230 may issue an operation amount notification and transmit the operation amount notification to the camera body 100 when the number of pulses is changed by the operation of the MF ring 212.

### Aspect Examples

Hereinafter, various aspects of the present disclosure will be exemplified.

A first aspect according to the present disclosure is an imaging apparatus to which an interchangeable lens is detachably attachable. The imaging apparatus includes: a communication interface that communicates data with the attached interchangeable lens; an image sensor that captures a subject image via the interchangeable lens to generate image data; a controller that controls an operation of the interchangeable lens with data communication via the communication interface; an image processor that performs electronic zoom processing to crop an image at a variable magnification from the image data generated by the image sensor; and a setting interface that sets the electronic zoom processing to a first operation member in response to a user operation of the setting interface, the first operation member being provided in the interchangeable lens. When the electronic zoom processing is not set to the first operation member by the setting interface, the controller controls the interchangeable lens to perform a predetermined operation in response to a user operation of the first operation member. When the electronic zoom processing is set to the first operation member by the setting interface, the controller disallows the predetermined operation by the interchangeable lens and controls the image processor to perform the electronic zoom processing in response to the user operation of the first operation member.

A second aspect is the imaging apparatus according to the first aspect, wherein the first operation member is provided to output an operation amount indicating a degree of the user operation thereof on the interchangeable lens. When the electronic zoom processing is set to the first operation member, the controller receives the operation amount of the first operation member in turn from the interchangeable lens via the communication interface, and controls the image processor to perform the electronic zoom processing with changing the magnification according to the received operation amount.

A third aspect is the imaging apparatus according to the second aspect, wherein the controller receives characteristic information from the attached interchangeable lens via the communication interface, the characteristic information regarding the first operation member, and manages a correspondence between the operation amount and the magnification, based on the characteristic information of the first operation member and a range in which the magnification is settable in the electronic zoom processing.

A fourth aspect is the imaging apparatus according to any one of the first to third aspects, wherein the setting interface includes a switcher that switches an operation mode of the imaging apparatus among a plurality of operation modes in response to the user operation of the setting interface, the plurality of operation modes including a first operation mode corresponding to the predetermined operation. The switcher does not set the electronic zoom processing to the first operation member when the operation mode of the imaging apparatus is switched to the first operation mode. The switcher sets the electronic zoom processing to the first operation member when the operation mode of the imaging apparatus is switched to a second operation mode different from the first operation mode.

A fifth aspect is the imaging apparatus according to any one of the first to fourth aspects, wherein the first operation member is provided to perform a focus adjustment operation as the predetermined operation, the focus adjustment operation adjusting a focus position in the interchangeable lens in response to the user operation of the first operation member. The controller disallows the focus adjustment operation by the first operation member when the electronic zoom processing is set on the first operation member by the setting interface.

A sixth aspect is the imaging apparatus according to any one of the first to fifth aspects, wherein the interchangeable lens includes a zoom lens and a second operation member for optical zoom by the zoom lens. The setting interface includes a first option and a second option, the first option allocating the electronic zoom processing to the first operation member and the second option allocating the electronic zoom processing together with the optical zoom to the second operation member.

A seventh aspect is the imaging apparatus according to the sixth aspect, wherein the interchangeable lens further includes a driver that drives the zoom lens to control the optical zoom. The setting interface further includes a third option disallowing the optical zoom and allocating the electronic zoom processing to the second operation member.

An eighth aspect is the imaging apparatus according to any one of the first to seventh aspects, further including a display that displays at least one of an image or a menu screen, wherein the interchangeable lens includes a zoom lens and a second operation member for optical zoom by the zoom lens. The controller causes the display to independently display information indicating the magnification for the electronic zoom processing with the first operation member and information indicating another magnification for the optical zoom with the second operation member.

A ninth aspect is an interchangeable lens detachably attachable to an imaging apparatus. The interchangeable lens includes: a communication interface that communicates data with the attached imaging apparatus; an optical system that forms an image on an image sensor of the imaging apparatus, based on incident light; an operation member that receives a user operation for the optical system; and a controller that controls an operation of the optical system according to the user operation of the operation member, based on information received from the imaging apparatus via the communication interface. When electronic zoom processing of the imaging apparatus is not set to the operation member, the controller performs a predetermined operation by the optical system in response to the user operation of the operation member. When the electronic zoom processing is set to the operation member, the controller does not perform the predetermined operation by the optical system in response to the user operation of the operation member.

A tenth aspect is the imaging apparatus according to the tenth aspect, wherein the operation member is provided to output an operation amount indicating a degree of the user operation thereof on the interchangeable lens. The controller transmits the operation amount of the operation member to the imaging apparatus via the communication interface when the electronic zoom processing is set to the operation member.

In the above, the embodiments have been described as examples of the techniques in the present disclosure. For that purpose, the accompanying drawings and the detailed description are provided.

Therefore, the components illustrated in the accompanying drawings and described in the detailed description not only include components essential for solving the problem but also can include, to exemplify the techniques, components that are not essential for solving the problem. For this reason, it should not be immediately recognized that those unnecessary components are necessary only because those unnecessary components are described in the accompanying drawings or the detailed description.

Since the embodiments described above are merely examples of the techniques in the present disclosure, various modifications, replacements, additions, omissions, and the like can be made in the scope of the claims or in an equivalent scope thereof.

The present disclosure is applicable to an imaging apparatus having an electronic zoom function, and an interchangeable lens.

1. An imaging apparatus to which an interchangeable lens is detachably attachable, the imaging apparatus comprising:
a communication interface that communicates data with the attached interchangeable lens;
an image sensor that captures a subject image via the interchangeable lens to generate image data;
a controller that controls an operation of the interchangeable lens with data communication via the communication interface;
an image processor that performs electronic zoom processing to crop an image at a variable magnification from the image data generated by the image sensor; and
a setting interface that sets the electronic zoom processing to a first operation member in response to a user operation of the setting interface, the first operation member being provided in the interchangeable lens, wherein
when the electronic zoom processing is not set to the first operation member by the setting interface, the controller controls the interchangeable lens to perform a predetermined operation in response to a user operation of the first operation member, and
when the electronic zoom processing is set to the first operation member by the setting interface, the controller disallows the predetermined operation by the interchangeable lens and controls the image processor to perform the electronic zoom processing in response to the user operation of the first operation member.

2. The imaging apparatus according to claim 1,
wherein the first operation member is provided to output an operation amount indicating a degree of the user operation thereof on the interchangeable lens,
wherein when the electronic zoom processing is set to the first operation member, the controller
receives the operation amount of the first operation member in turn from the interchangeable lens via the communication interface, and
controls the image processor to perform the electronic zoom processing with changing the magnification according to the received operation amount.

3. The imaging apparatus according to claim 2,
wherein the controller
receives characteristic information from the attached interchangeable lens via the communication interface, the characteristic information regarding the first operation member, and
manages a correspondence between the operation amount and the magnification, based on the characteristic information of the first operation member and a range in which the magnification is settable in the electronic zoom processing.

4. The imaging apparatus according to claim 1, wherein
the setting interface includes a switcher that switches an operation mode of the imaging apparatus among a plurality of operation modes in response to the user operation of the setting interface, the plurality of operation modes including a first operation mode corresponding to the predetermined operation,
the switcher does not set the electronic zoom processing to the first operation member when the operation mode of the imaging apparatus is switched to the first operation mode, and
the switcher sets the electronic zoom processing to the first operation member when the operation mode of the imaging apparatus is switched to a second operation mode different from the first operation mode.

5. The imaging apparatus according to claim 1, wherein
the first operation member is provided to perform a focus adjustment operation as the predetermined operation, the focus adjustment operation adjusting a focus position in the interchangeable lens in response to the user operation of the first operation member, and
the controller disallows the focus adjustment operation by the first operation member when the electronic zoom processing is set on the first operation member by the setting interface.

6. The imaging apparatus according to claim 1, wherein
the interchangeable lens includes a zoom lens and a second operation member for optical zoom by the zoom lens, and
the setting interface includes a first option and a second option, the first option allocating the electronic zoom processing to the first operation member and the second option allocating the electronic zoom processing together with the optical zoom to the second operation member.

7. The imaging apparatus according to claim 6, wherein
the interchangeable lens further includes a driver that drives the zoom lens to control the optical zoom, and
the setting interface further includes a third option disallowing the optical zoom and allocating the electronic zoom processing to the second operation member.

8. The imaging apparatus according to claim 1, further comprising a display that displays at least one of an image or a menu screen, wherein
the interchangeable lens includes a zoom lens and a second operation member for optical zoom by the zoom lens, and
the controller causes the display to independently display information indicating the magnification for the electronic zoom processing with the first operation member and information indicating another magnification for the optical zoom with the second operation member.

9. An interchangeable lens detachably attachable to an imaging apparatus, the interchangeable lens comprising:
a communication interface that communicates data with the attached imaging apparatus;
an optical system that forms an image on an image sensor of the imaging apparatus, based on incident light;
an operation member that receives a user operation for the optical system; and
a controller that controls an operation of the optical system according to the user operation of the operation member, based on information received from the imaging apparatus via the communication interface, wherein
when electronic zoom processing of the imaging apparatus is not set to the operation member, the controller performs a predetermined operation by the optical system in response to the user operation of the operation member, and
when the electronic zoom processing is set to the operation member, the controller does not perform the predetermined operation by the optical system in response to the user operation of the operation member.

10. The interchangeable lens according to claim 9, wherein
the operation member is provided to output an operation amount indicating a degree of the user operation thereof on the interchangeable lens, and
the controller transmits the operation amount of the operation member to the imaging apparatus via the communication interface when the electronic zoom processing is set to the operation member.
